(19) United States
(12) Patent Application Publication
(10) Pub. No.: US 2005/0120846 A1
(43) Pub. Date: Jun. 9, 2005

(54) Method and device for the mechanical-thermal separation of different materials

(76) Inventors: Frank Ellner, Villingen-Schwenningen (DE); Roswitha Maurer, Villingen-Schwenningen (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/258,986

(22) PCT Filed: May 2, 2001
(86) PCT No.: PCT/EP01/04897

(30) Foreign Application Priority Data
May 4, 2000 (DE) 100 21 630.7

(51) Int. Cl. B26D 1/15

(52) U.S. Cl. 83/171; 83/676

(57) ABSTRACT

The invention relates to a method and system for the mechanical-thermal separation of different materials such as textile flat structures, threads, and plastic films by heating and simultaneously compacting the material. According to the invention, the material is fed through a gap which is formed between a tool (2) and an opposing surface (3) that touches the tool while forming a point. An adjustable electrical current is conducted over the contact point (5) in such a manner that a temperature profile (14), which is adapted to the density of the material, in the area of the contact point (5) is set such that the temperature of the tool (2) and opposing surface (3), independent of their shape and cross-section up to the contact point, is, in the advance direction of the material (1), increased to the same maximum value, and the contact point is heated in a defined manner.

The invention relates to a method and a device for mechanically-thermally severing different materials such as yarns, textile fabrics and plastic sheets by simultaneously heating and compacting as defined in claims 1 and 6.

According to the known state of the art, methods and devices are known, for which indirectly heated, stationary or rotating knives as well as also directly heated, current-carrying knives or wire hoops press on a counter surface and, in so doing, melt and sever materials passing through.

In the DE 40 11 293 A1, a device for thermally severing textile fabrics is described, for which a heated wire hoop acts with a flattened crest on the textile fabric, severs it by a combined thermal and mechanical action and fuses the severed edge.

The DE 30 27 440 A1 discloses a severing device for textile labels, which consists of a knife, which can be heated, and a pressure pad, which can be pressed against the label tape in the direction of the severing edge of the knife.

The DE 22 14 554 discloses a device for cutting tapes, for which a cutting tool is provided, which has several cutting knives, which are disposed next to one another and press against a heated knife contact roller. The sheet of fabric is brought into contact with the knife contact roller only in the regions, in which the cutting too, which is not heated, presses against the knife contact roller.

From the DE 25 02 724, it is known that the temperature of the blade for severing label tape is kept above the melting temperature of the tape and the temperature of the plate opposite to the blade, is maintained at, a significantly lower level.

From the DE 195 36 963 A1 and 196 04 735 A1, a device is known for producing textile tape from a wide sheet, for which a family of melting/cutting edges is provided, which consists of two elements, which are acted upon against one another by a force and one of which is heated. The wide sheet is pulled between the cutting elements, which are in contact with one another. In order to obtain a soft, melted edge at the tapes, a clamping pad is disposed, which is pressed against the face of the wide sheet in the region of the melt cut.

From the EP 0549748 B1, a method is known for cutting thermally, for which the active part of the hot cutting wire is disposed in a direction at right angles to the direction of movement of the sheet of textile and held inclined at an angle between 0° and 90° against the guiding plane. By these means, an inclined cut is achieved, which assigns a portion of the molten mass to a scrap strip and for which the melted edge is at the back of the textile sheet.

It is a disadvantage of the known methods and devices that, for this method, in each case the whole severing organ is heated and that the temperature of the severing organ decreases in the direction of the contacting or severing site. An optimum edge quality is obtained if the material is compacted mechanically and the melting temperature of the material is attained or exceeded briefly at one point, in order to fix the edge in this state. However, because of the higher temperature of conventional severing organs the melting presses commences already with the contact between the severing organ and the material, so that a mechanical compaction cannot take place. Moreover, the energy required increases out of proportion as the requirements for acceptation increase, for example, at higher speeds, in order to ensure that sufficient heat flows to the severing site. Even for very thin materials, for which the energy required is actually a minimum, the whole of the severing organ must always be brought to the necessary melting or severing temperature. There are applications, for which only a severing is required as an alternative for cutting, melting of the edges not being necessary. For this purpose the severing organ should be as thin as possible. For conventional methods, however, this is limited by the heat flow required while, at the same time, mechanical stability is maintained.

It is an object of the invention to develop a method and a device of the type described, with which the disadvantages of the state of the art are avoided and the material-specific severing task is ensured with a num amount of energy and a combination of temperature increase and mechanical compaction, which can be varied within wide limits.

This objective is accomplished with a method and a device, defined by the characterizing features of claims 1 and 2. According to the method for the mechanical/thermal severing of different materials, such as textile fabrics, yarns and plastic sheets, by heating and simultaneously compacting the material, the latter is passed through a gap, which is formed between a tool and a counter surface touching the tool punctually, a controllable electric current being passed over the point of contact so that a temperature profile, adapted the thickness of the material, is produced in the region of the point of contact in such a manner, that the temperature of the tool and the counter surface, independently of their shape and cross section, increases in the direction of the point of contract, that is in the feeding direction of the material, to the same maximum value and the point of contact is heated in a defined manner.

A manually adjustable or automatically controlled current flows though the contact point, heating it. Due to the geometry of the tool and the counter surface, as well due to their material properties (thermal conductivity, electric conductivity, material combinations, coating surface treatment, etc.), the desired temperature as well as the material properties (compaction, friction, squeezing, etc.) can be affected within wide limits.

It is advantageous to work with very low voltages of not more than 1 volt and moderate to high currents, since this expands the selection of materials in relation to those with a moderate to good conductivity.

For the arrangement for mechanically/thermally severing different materials, such as textile fabrics, yarns and plastic sheets, by means of a tool and a counter surface, the tool is disposed with respect to the counter surface so that a wedge-shaped gap with a punctual contacting site is formed, through which the material is passed, the tool and the counter surface being connected with a controllable circuit, so that a controllable current flows thought the contact site.

The tool and the counter surface may be stationary or one of the two may rotate or oscillate or both may rotate or oscillate. In the rotating version, profiled tools (zigzag) or perforated tools are, for example, also conceivable, provided that it is insured that the contact is always maintained.

Since the highest temperature always exists at the point of contact, a temperature sensor can be mounted there directly with contacting or contactless (IR) detection, as a result of which very short adjustment times can be realized.

The current flowing through the point of contact can be used, at the same time, as an error signal. Each interruption in the current, even if it is of very short duration, necessarily results in materials not being severed.

If necessary or desirable, a soft severing edge in the material is attained particularly owing to the fact that only a heated point is used for the cutting, the heat is developed in the severing site and the temperature of the material before the severing is still below the melting point.

Advantageous developments of the invention are given in the dependent claims.

The invention is described in greater detail in the following by an example of the device severing polyester material. In the associated drawing,

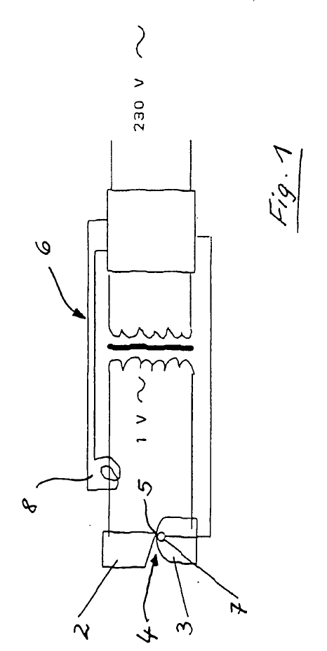

FIG. 1 shows a diagrammatic representation of an inventive device,

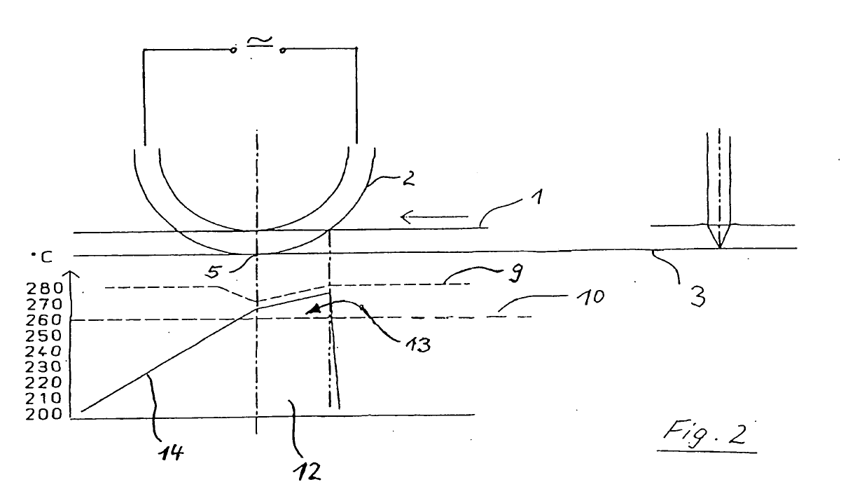

FIG. 2 shows the diagrammatic representation of the temperature profile at the severing site with a device of the state of the art and

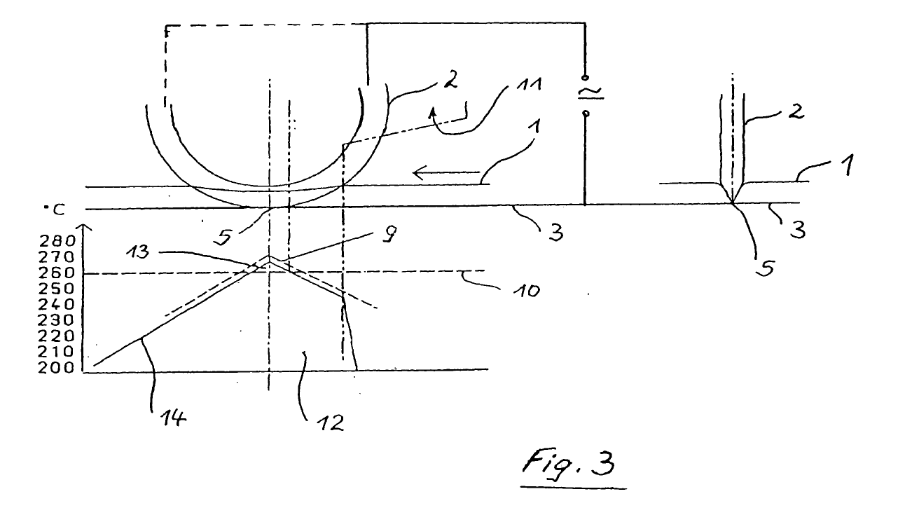

FIG. 3 shows a diagrammatic representation of the temperature profile at the severing site (in region of the point of contact) when the inventive method is used

As shown in FIG. 1, the device for mechanically/thermally severing different materials pursuant to the invention consists essentially of a tool 2 and a counter surface 3. The tool 2 and the counter surface 3 are positioned with respect to one another so that a wedge-shaped gap 4 with a punctual contacting site 5, though which the material 1 is passed (FIGS. 2 and 3), is formed between them.

The tool 2 and the counter surface 3 are connected with a controllable circuit 6, over which the contacting site 5 can be heated in a controlled manner.

For controlling the temperature of the contacting site 5, a temperature sensor 7, which can measure the temperature by direct contact or in a contactless manner, is connected at the contacting site 5.

For obtaining an error signal, a current detector 8 is disposed in the lead to or from the contact point 5.

The tool 2 and the counter surface 3 can have different geometric shapes.

In order to explain the inventive method, the temperature profile at the severing site or contacting site 5 when the known method and devices are used (FIG. 2) is compared with that of the inventive method and device (FIG. 3).

For a direct comparison, the same masses and geometry of the severing organs (tool 2) were selected. With these, a somewhat compressible polyester material was to be severed, for example. The melting point 10 of the material 1 is at 260° C.

For the conventional method of FIG. 2, the melting process commences when the first fibers of material 1 come into contact with the current-carrying severing hoop 2, because the temperature of the latter, due to the design of the device, must already be appreciably above the melting temperature 10 of the material 1. For this reason also, mechanical compaction is not possible and the displacement of the material 1 by the hoop 2 results in the formation of a slight bead. Since the heat is supplied over the hoop 2 and the contacting site 5 provides heat to the counter surfaced 3 and the material 1, the hoop 2 has the lowest temperature at the place 5 where it contacts the counter surface 3. However, this temperature must still always be higher than the melting temperature 10 of the material 1, in order to sever the latter reliably. As the speed of the material increases (material is transported in the direction of the arrow), the temperature difference becomes larger, because only little thermal energy is absorbed at the sections of the hoop not in contact with the material.

In contrast to this, the melting temperature 10 is exceeded less and for a shorter time for the inventive method according to the representation in FIG. 3. In the plasticization zone 12, mechanical compaction 11 can take place, which compensates for the displacement of material in the melting zone 13 and avoids the formation of a bead. As the speed of the material increases (material transported in the direction of the arrow), additional thermal energy is supplied over the contact point 5 to the melting zone 13 and absorbed there by the material 1. By controlling the temperature at the contact point 5, it is possible to ensure that the amount of energy supplied is only sufficient for maintaining the temperature level.

According to an advantageous embodiment of the method, the tool 2 and/or the counter surface 3 are preheated to an average temperature level in relation to the maximum temperature, which is to be attained in the region of the contact point 5. The basic temperature may amount, for example, to 80% of the melting temperature of the material 1, so that only the thermal energy difference for raising the temperature from the basic to the maximum and necessary for the cutting/melting, must still be introduced into the contact point 5.

The combination of conventionally heating (basic temperature) the tool 2 and/or the counter surface 3 and of heating the contact point 5 by the method, expands the range of applications of the method with regard to material thicknesses, which are to be processed, and the feeding speeds of the material 1.

When the inventive method is used for materials, which essentially cannot be compressed, it should be noted that, in order to avoid excessive bead formation, the thickness of the tool 2 must be changed or minimized correspondingly.

If more melting of the edges is desired, this can be achieved by the appropriate geometric shaping of the tool 2 or of the counter surface 3.

The inventive method ensures further advantageous applications.

The counter surface 3 can be constructed so that, by active heating over the contact point 5, it brings a considerable amount of energy from the opposite side into the material 1.

If melting of the edges is undesirable (melting usually is always associated with some hardening), a plasticized compaction of the edge can be achieved at the contact point 5 at a temperature level below the melting point of the material by increased mechanical squeezing. With that, materials, containing portions, which are not thermoplastic, can also be severed.

The following can be severed particularly advantageously with this method:
very thin, thermoplastic materials, since the thermal energy is a minimum,
thin to average thermoplastic materials, which are to be fused easily without thickening the edges,
up to average thicknesses of compressible, thermoplastic materials and
materials, suitable for squeezing/cutting, for which the cutting forces can be reduced by the action of heat and/or the edges are to be fused.

1. Method for the mechanical/thermal severing of different materials, such as textile fabrics, yarns and plastic films by heating and simultaneously compacting the material, the material being passed in the transporting direction through a gap, which is closed at one end and formed between a tool and a counter surface, contacting the tool at one point, a controllable electric current being passed through this contact point so that a temperature profile, adapted to the thickness of the material, develops in the area of the contact point, the temperatures of the tool and of the counter surface, independently of their shape and cross-section, increasing in the direction of the contact point, that is, in the transporting direction of the material, to the same maximum value.

2. The method of claim 1, characterized in that the gap is wedge-shaped and that the tool and/or the counter surface can be constructed to be stationary and/or rotating and/or oscillating.

3. The method of claim 1, characterized in that a directly contacting or contactless temperature sensor is used at the contact point for shortening the adjustment times.

4. The method of claim 1, characterized in that the tool and/or the counter surface are preheated to a basic temperature, which is related to maximum value of the temperature, which is to be attained at the contact point.

5. The method of claim 1, characterized in that the current flowing through the contact point is used as an error signal.

6. Arrangement for mechanically/thermally severing certain materials such textile fabrics, yarns or plastic sheets, by means of a tool (2) and a counter surface (3), the tool (2) being disposed with respect to the counter surface (3), so that a wedge-shaped gap (4) is formed, which is closed at one end by a contact point (5) and through which the material (1) is passed, the tool (2) and the counter surface (3) being connected with a controllable circuit (6), so that a controllable current flows through the contact point (5).

7. The arrangement of claim 6, characterized in that, for obtaining am error signal and/or for controlling the temperature of the contact site (5), a current detector (8) is disposed in the lead from or to the contact site (5) and a temperature sensor (7) is disposed at the contact site (5).

8. The arrangement of claim 6, characterized in that the geometry and material properties as well as the surface treatment of the tool (2) and of the counter surface (3) are matched to one another, in order to obtain a desired temperature profile in the area of the contact point (5).
